(19) United States
(12) Patent Application Publication
(10) Pub. No.: US 2026/0234321 A1
(43) Pub. Date: Aug. 13, 2026

(54) A METHOD OF CURING AN EPOXIDE AND USE OF THE CURED EPOXIDE

(71) Applicant: ADITYA BIRLA CHEMICALS (THAILAND) LTD., BANGKOK (TH)

(72) Inventors: Pradip DUBEY, MAHARASHTRA MUMBAI (IN); Szymon KOSINSKI, MAP TA PHUT, RAYONG (TH); Amit DIXIT, MAP TA PHUT, RAYONG (TH); Thipa NAIYAWAT, MAP TA PHUT, RAYONG (TH); Kanyarat SITTIPUMMONGKOL, MAP TA PHUT, RAYONG (TH); Nok NOIPHOM, MAP TA PHUT, RAYONG (TH)

(21) Appl. No.: 19/156,148

(22) PCT Filed: Feb. 19, 2024
(86) PCT No.: PCT/IB2024/051559

§ 371 Date: Aug. 13, 2025

(30) Foreign Application Priority Data
Feb. 18, 2023 (IN) 202321003699

(51) Int. Cl. C08G 59/32; C08G 59/50; C08K 5/00; C09D 5/03; C09D 163/00; C09J 163/00

(52) U.S. Cl. CPC C08G 59/3218; C08G 59/5033; C08K 5/005; C09D 5/03; C09D 163/00; C09J 163/00

(57) ABSTRACT

The invention relates to a method of curing an epoxide prepared from phenolic compounds such that the cured epoxy resin has a glass transition temperature (Tg) of at least 245° C. The method comprises: (a) mixing the epoxide at a temperature of 25 to 100° C. with at least one hardener, a naturally occurring aliphatic polyamine or at least one analogue thereof or combination thereof, and at least one antioxidant; (b) heating the mixture of step (a) at 100 to 130° C. for 1 to 3 hrs; (c) heating the partially cured mixture of step (b) at 130 to 160° C. for 1 to 3 hrs; and (d) heating the substantially cured mixture of step (c) at 160 to 200° C. for 3 to 5 hrs; wherein steps (b) to (d) were performed in an atmosphere of nitrogen; and wherein the epoxide is trans-resveratrol trisepoxide of Formula I, a tetraepoxide of Formula II or a diepoxide of Formula III,

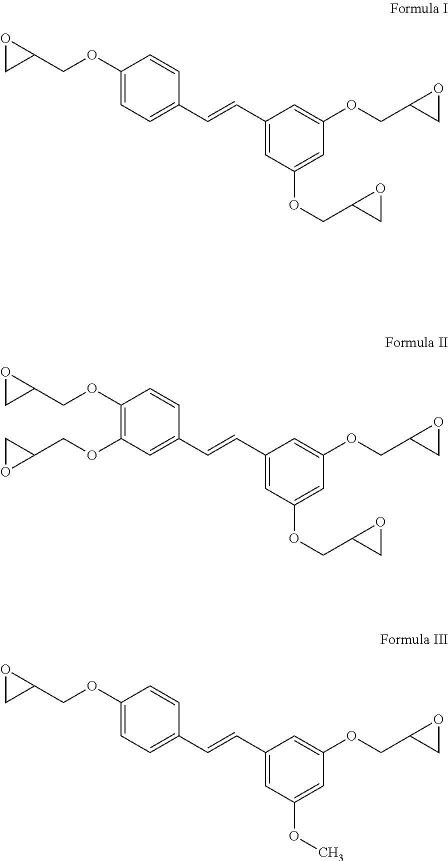 [SMILES: C(=C\c1cc(OCC2CO2)cc(OCC2CO2)c1)/c1ccc(OCC2CO2)cc1 ; C(=C\c1ccc(OCC2CO2)c(OCC2CO2)c1)/c1cc(OCC2CO2)cc(OCC2CO2)c1 ; COc1cc(/C=C/c2ccc(OCC3CO3)cc2)cc(OCC2CO2)c1]

### FIELD OF THE INVENTION

The present invention relates in general to epoxy resins. In particular, the present invention relates to a novel method for curing an epoxide for producing thermoset polymer with optimum Tg. It also relates to developing high Tg epoxy based adhesives.

### DESCRIPTION OF THE BACKGROUND ART

Epoxy resins are an important class of thermosetting compounds. They have diverse applications and have been widely used in adhesives, structural materials, lacquer, ceramic manufacturing, printed circuit boards, microelectronics packaging, aerospace industry, etc. Epoxy resins have also been used as an industry standard plastic/polymer matrix for the manufacture of fiber-reinforced polymer composites, also known as plastic composite materials.

Epoxy resin thermosets are used as performance material for composite applications such as aerospace, automobiles, military, space & defense equipment, wind mill composites, structural adhesives etc. Another area of usage is electrical & electronics applications such as electrical components, electronic components, printed circuit boards PCBs, moulding & potting etc. A wide range of applications also exists in civil & construction such as structural components, epoxy cements, floor coatings, metal coatings, marine coatings, paints and decorative art pieces, etc. Due to superior performance of epoxy resins, they are also preferred for coating applications such as can coatings, powder coatings, food & packaging coatings, etc.

Epoxy offers a unique combination of thermal, mechanical & chemical resistance properties that are unattainable with other thermoset resins. Epoxy resins are available in a wide variety of physical forms from low viscosity liquid epoxy to high melting point solid epoxy resins suitable for wide range of applications. Epoxy resins offer superior mechanical and thermal properties such as high strength, high chemical and solvent resistance, low shrinkage, excellent adhesion to varying substrates, economical with low toxicity.

A majority of epoxy materials are based on bis(4-hydroxyphenylene)-2,2-propane, known as bisphenol A (BPA). BPA is one among the extensive epoxy resin precursors owing to its unique molecular structure produced from petroleum feedstocks.

Thermoset polymers lose their mechanical strength, stiffness and adhesive properties beyond the glass transition temperature (Tg); thus, in applications where they are exposed to high temperatures, high Tg thermosets are needed.

Therefore, there is a constant need to improve the Tg of thermoset polymers thereby extending the usability to structural composite applications of the cured thermoset polymers. Furthermore, there is a need for high Tg adhesives for electrical & electronic applications.

### SUMMARY OF THE INVENTION

According to an embodiment of the invention, there is provided a method of curing an epoxide prepared from phenolic compounds such that the cured epoxy resin has a glass transition temperature (Tg) of at least 245° C., the method comprising:
(a) mixing the epoxide at a temperature of 25 to 100° C. with
   at least one hardener or a naturally occurring aliphatic polyamine or at least one analogue thereof or combination thereof, and at least one antioxidant
(b) heating the mixture of step (a) at 100 to 130° C. for 1 to 3 hrs;
(c) heating the partially cured mixture of step (b) at 130 to 160° C. for 1 to 3 hrs; and
(d) heating the substantially cured mixture of step (c) at 160 to 200° C. for 3 to 5 hrs;
wherein steps (b) to (d) were performed in an atmosphere of nitrogen; and
wherein the epoxide is trans-resveratrol trisepoxide of Formula I, a tetraepoxide of Formula II or a diepoxide of Formula III,

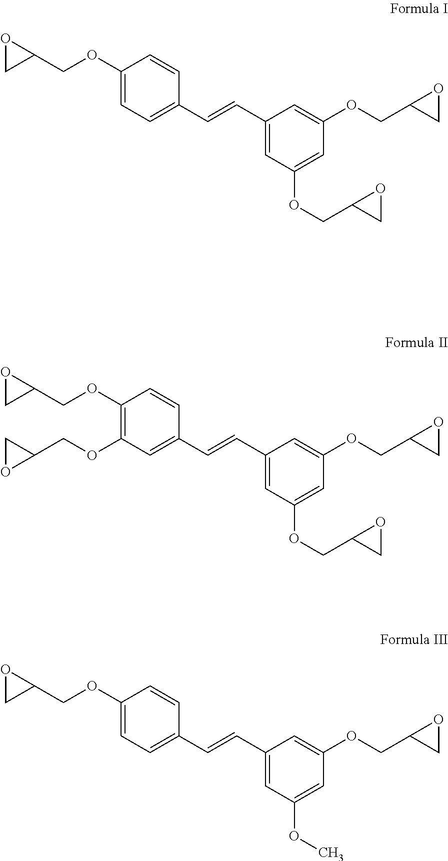 [SMILES: C(=C\c1cc(OCC2CO2)cc(OCC2CO2)c1)/c1ccc(OCC2CO2)cc1 ; C(=C\c1ccc(OCC2CO2)c(OCC2CO2)c1)/c1cc(OCC2CO2)cc(OCC2CO2)c1 ; COc1cc(/C=C/c2ccc(OCC3CO3)cc2)cc(OCC2CO2)c1]

According to another embodiment of the invention, there is provided use of the cured epoxide prepared by the method described hereinabove for preparing high Tg epoxy based adhesives, electronic moulding compounds, composites and powder coatings.

### BRIEF DESCRIPTION OF DRAWINGS

FIG. 1 is profiles of glass transition temperature of RVTE systems of Examples 1-3.

FIG. 2 is the profile of ultimate glass transition temperature of RVTE/DETDA systems of Example 5.

FIG. 3 is the profile of ultimate glass transition temperature of RVTE/DETDA systems of Example 6.

FIG. 4 is glass transition temperature profile of thermoset systems consisting of RVTE/MHHPA/DMP30.

FIG. 5 is glass transition temperature profile of thermoset systems consisting of RVTE/DETDA/KINOX10.

FIG. 6 is glass transition temperature profile of thermoset systems consisting of RVTE/DETDA/KINOX10/KINOX68.

FIG. 7 is the DMA profile of thermoset systems consisting of RVTE/DETDA/KINOX10/KINOX68.

FIG. 8 shows tensile lap shear strength specimens before (left) after (right) tensile lap shear strength using thermoset system consisting of RVTE/DETDA.

FIG. 9 is glass transition temperature profile of thermoset systems consisting of RVTE and histamine.

### DESCRIPTION OF THE INVENTION

In describing and claiming the invention, the following terminology will be used in accordance with the definitions set forth below. Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described herein. As used herein, each of the following terms has the meaning associated with it in this section. Specific and preferred values listed below for individual process parameters, substituents, and ranges are for illustration only; they do not exclude other defined values or other values falling within the preferred defined ranges.

As used herein, the term “phenolic compounds” refers to resveratrol, pinostilbene or piceatannol.

As used herein, the term “Tg or glass transition temperature” refers to the temperature region where the cured thermoset polymer transitions from a rigid, glassy material to a flexible and rubbery material.

As used herein, ‘RVTE’ refers to resveratrol trisepoxide, ‘MDA’ to 4,4′-methylenedianiline, ‘DETDA’ to diethyltoluenediamine, ‘MHHPA’ to methylhexahydrophthalic anhydride, ‘KINOX10’/‘KINOX68’ are commercially available antioxidants and ‘DMP-30’ to 2,4,6-tris(dimethylaminomethyl) phenol, which is commercially available catalyst for epoxy.

As epoxies are thermosetting materials, the final cured epoxy material does not melt when heated but undergoes a phase change at elevated temperatures. The Tg is determined by a number of factors such as the chemical nature of the epoxy resin, the type of curing agent and the degree of curing.

Curing agents and curing temperature also influences Tg. Lower Tg results in reduction in thermal stability of the thermoset polymers. Typically, thermoset polymers with the highest Tg have the best heat resistance and therefore deliver the best mechanical properties at high temperature. In an embodiment of the invention, there is provided a method of preparing thermoset polymers and curing the epoxy resin prepared from renewable phenolic compounds with at least one curing agent.

Preferably, the phenolic compound in the method of the invention is trans-resveratrol.

The hardener cant be diethyltoluenediamine (DETDA), 4,4′-methylenedianiline (MDA), methylhexahydrophthalic anhydride (MHHPA) or combinations thereof. The antioxidant is preferably a primary phenolic antioxidant or a secondary phosphite anti-oxidant or a combination thereof. The naturally occurring aliphatic polyamine can be histamine. Preferably, the weight ratio of epoxide:hardener:antioxidant is in the range of 100:25:0.2 to 100:35:1.

In an embodiment, the phenolic compound is resveratrol. Epoxy resins from BPA pose a threat to health due to its toxicity. Therefore, it is necessary to explore renewable raw materials to synthesize bio-based polymers to meet the growing demand for sustainable development by replacing BPA. Resveratrol is a polyphenol compound found in grapes, blueberries, and legumes. The greater thermal stability of the resveratrol-based resins was attributed to the stilbene structure and higher cross-link density of the networks. As such resveratrol is a sustainable alternative to BPA with the potential to be used in advanced high-temperature composite materials.

Renewable phenolic compounds stilbenoids trans- and cis-resveratrol, trans- and cis-pinostilbene and trans- and cis-piceatannol can be also prepared by Genetically Modified Organisms (GMO) which offer an attractive alternative to bio-based resveratrol and its analogs (Shrestha A, Pandey R P, Sohng J K. Biosynthesis of resveratrol and piceatannol in engineered microbial strains: achievements and perspectives. Appl Microbiol Biotechnol. 2019 April; 103(7):2959-2972. doi: 10.1007/s00253-019-09672-8. Epub 2019 Feb. 23. PMID: 30798357.) GMO derived products may be considered as renewable resources and they offer additional benefits to “natural phenolic compounds”. GMO derived resveratrol as a raw material in the described process has the potential to impart significant advantages to the process, such as making the process more economical, providing a raw material that is easier to purify, not dependent on variable harvest/limited availability of natural crops and providing higher volumes of raw material because of the ability to scale up, as required, and therefore providing higher volumes of end-product as compared to what would be practically and economically feasible in the case of “natural phenolic compounds”.

A number of research have been carried out where natural resveratrol is used as epoxy resin. Michael D. Garrison et al. recites a method of preparation epoxy resin where first resveratrol triepoxide is prepared from GMO-derived resveratrol (Synthesis and Characterization of High-Performance, Bio-Based Epoxy-Amine Networks Derived from Resveratrol, Michael D. Garrison, Markku A. Savolainen, Andrew P. Chafin, Joshua E. Baca, Austin M. Bons, and Benjamin G. Harvey, ACS Sustainable Chemistry & Engineering 2020 8 (37), 14137-14149, DOI: 10.1021/acssuschemeng.0c04816). RVTE is degassed for 5 min at 90° C. and then cured with MDA under N₂ for 18 h at 100° C., 2 h at 130° C., 2 h at 170° C., and 24 h at 200° C.

In an embodiment, the epoxy resin of use in present invention is trans-resveratrol trisepoxide (RVTE) as represented by formula I.

Trans-resveratrol trisepoxide is an epoxidized phenolic compound and is prepared by methods known in the art, comprising the steps of:
(a) adding epicholhydrin to a trans-resveratrol to obtain a slurry;
(b) adding a solution of sodium hydroxide to the slurry of step (a);
(c) filtering the slurry of step (b) to obtain a residue; and
(d) heating the residue at a predetermined temperature and under vacuum and for a duration.

The step (a) in the present invention is performed using trans-resveratrol. Also, step (a) in the present invention is performed at a temperature in the range of 80° C. to 100° C. under nitrogen atmosphere. The addition of sodium hydroxide in step (b) is performed using an addition funnel. Sodium hydroxide is dissolved in an organic solvent, preferably ethanol.

Subsequent to the addition of sodium hydroxide, the reaction mixture is stirred for a duration of 4 to 6 hours and at a temperature in the range of 80° C. to 100° C.

The filtering of step (c) is performed to eliminate sodium chloride. The residue obtained from the filtration is subjected to wash using distilled water and brine solution.

The residue is subsequently subjected to heating at a temperature in the range of 90° C. to 110° C. at a pressure in the range of 100 mbar. In an embodiment, the residue is further subjected to heating at a temperature in the range of 100° C. to 120° C. in vacuum.

The heated residue is allowed to cool to room temperature to obtain a waxy solid of ‘high hydrolyzable chlorine’ RVTE represented by Formula I having hydrolyzable chlorine (Hy-Cl) of 1-2%.

In an embodiment, ‘low hydrolyzable chlorine’ RVTE of Formula I with Hy-Cl of less than 0.25% is obtained by treatment of ‘high hydrolyzable chlorine’ RVTE with a small quantity of sodium hydroxide in an organic solvent, preferably methyl iso-butyl ketone at a temperature in the range of 70° C. to 75° C. under pressure of 250 mbar with simultaneous removal of water by distillation. The resulting solution is subjected to wash with water and 35% sodium hydrogen phosphate followed by vacuum distillation to remove the solvent. Hydrolyzable chlorine of resulting RVTE is below 0.25%, preferably below 0.15% and more preferably below 0.1%.

In another embodiment, the invention provides a reaction product of epoxy resin as represented by formula I-III and one or more curing agents as recited above.

The following experimental examples are illustrative of the invention but not limitative of the scope thereof:

### Example 1. Conventional Process Described by M. D. Garrison et al (for Reference)

To a flask equipped with a heating mantle, thermocouple, mechanical stirrer, addition funnel and efficient condenser resveratrol 150.3 g and epichlorohydrin 1216 g were charged (Epichlorohydrin/Resveratrol=20:1 mole ratio). Slowly solution of 50% NaOH (158 g) (mole ratio NaOH/resveratrol=3:1) and ethanol 564.3 g was added while maintaining reaction at 80-90° C. for 195 min and then reaction was maintained at 82° C. (reflux temperature) for 5 h. Reaction mixture was filtered to separate NaCl salt and filtrate was concentrated by distillation at 50-55° C. under vacuum 220 mbar. The concentrate was washed with solution of 25% NaCl (151.7 g) and next three times with water (1320 g), and with 25% NaCl (1160 g). Vacuum distillation was performed to remove rest of solvent at 110° C. under vacuum 40 mbar and later at 110° C. under vacuum 6 mbar to obtain product 209.6 g (EEW=157 g/eq, HyCl=2.0%). Note: EEW (value of 157) matches that obtained by Garrison (156.6), but there is no literature data to compare HyCl.

### Example 2: Process of the Invention Modifying Process Described by M. D. Garrison et al (for Reference)

To a flask equipped with a heating mantle, thermocouple, mechanical stirrer, addition funnel and efficient condenser resveratrol 300.8 g and epichlorohydrin 2438 g were charged (Epichlorohydrin/Resveratrol=20:1 mole ratio). Slowly solution of 50% NaOH (316.3 g) (mole ratio NaOH/resveratrol=3:1) and ethanol 602 g was added while maintain reaction at 80-90° C. for 195 min and then reaction was maintained at 83° C. (reflux temperature) for 5 h. Reaction mixture was filtered to separate NaCl salt and washed with solution of 25% NaCl (204 g) and next three times with water (602 g), and twice with 25% NaCl (250 g and 118 g) and next with water (408 g). Vacuum distillation was performed to remove solvent at 110° C. under vacuum 40 mbar and later at 110° C. under vacuum 6 mbar to obtain product 396.6 g (EEW=154.5 g/eq, HyCl=0.9003%).

### Example 3: Phase Transfer Catalyst (PTC) Process

To a flask equipped with a heating mantle, thermocouple, mechanical stirrer, Dean Stark apparatus and efficient condenser, resveratrol 250 g and epichlorohydrin 2026.4 g were charged (Epichlorohydrin/Resveratrol=20:1 mole ratio). Heated to 80° C. then charged with Tetraethylammonium bromide (1.25 g) (0.5% by wt of resveratrol). The mixture was stirred at 119-121° C. (reflux temperature) for 5 h. Then, the mixture was cooled down to 65° C. Next, the mixture was heated to 60-65° C. and kept under vacuum 205 mbar. After that, a solution of 50% NaOH (258.7 g) (mole ratio NaOH/resveratrol=2.94:1) was added with a uniform rate along with water removal continuously over 160 minutes. When sodium hydroxide solution addition was completed, the reaction was continued for 30 minutes. Vacuum distillation was performed to remove epichlorohydrin at 135° C. under vacuum 40 mbar. Next, 670 g of methyl isobutyl ketone and 568 g water were added in the crude product. The mixture was stirred at 70-75° C. for 15 minutes. Aqueous layer was separated. 223 g of 35% sodium dihydrogen phosphate solution was added. The mixture was stirred at 70-75° C. for 15 minutes. Aqueous layer was separated. Vacuum distillation was performed to remove solvent at 140° C. under vacuum 40 mbar to obtain resveratrol triepoxide 415 g (EEW 139.5 g/eq, HyCl=0.4523%)

### Example 4: Re-Processing of RVTE Obtained by Process of Example 3 to Obtain Low Hy-Cl RVTE

To a flask equipped with a heating mantle, thermocouple, mechanical stirrer, Dean Stark apparatus and efficient condenser, 398. g of triepoxy resveratrol (prepared as described in Example 3) containing Hy-Cl 0.4523% was dissolved in 672.5 g of methyl isobutyl ketone. The solution was heated to 70-75° C. and kept under vacuum at 250 mbar. A solution of 50% sodium hydroxide (4.87 g, 0.061 mole) was added at a uniform rate at 70-75° C. under vacuum with continuous water separation. After sodium hydroxide addition was completed, the reaction was continued for 30 minutes and 11 g of water was added. The mixture was stirred at 70-75° C. for 15 minutes. Aqueous layer was removed. 214 g of 35% sodium dihydrogen phosphate solution was added. The mixture was stirred at 70-75° C. for 15 minutes. Aqueous layer was removed. Vacuum distillation was performed to remove solvent at 140° C. under vacuum 40 mbar to obtain resveratrol triepoxide 394.6 g (EEW 138.7 g/eq, HyCl=0.1807%).

Low hydrolyzable chlorine content is beneficial in epoxy resins, especially to prevent an electro-corrosion reaction, which is useful for adhesives and electric/electronic materials.

### Example 5 Modifying the Process Described by M. D. Garrison et al (for Reference) by Use of Air Instead of Nitrogen

Trans-Resveratrol tris (epoxide) (10 μm) was mixed with 4,4′-methylenedianiline (MDA) (3.1 μm), both pre-heated in an oven at a temperature of 120° C. The mixture was allowed open to the air to be cured at multiple temperature profiles at different duration as follows: (1) Curing at 100° C. for a duration of 18 hours (2) Curing at 130° C. for a duration of 2 hours (3) Curing at 170° C. for a duration of 2 hours (4) Curing at 200° C. for a duration of 24 hours

### Example 6 Modifying the Process Described by M. D. Garrison et al (for Reference) by Use of Air Instead of Nitrogen

Trans-Resveratrol tris (epoxide) (10 μm) was mixed with 4,4′-methylenedianiline (MDA) (3.1 μm), pre heated in an oven at a temperature of 120° C. The mixture was allowed to be cured open to the air at multiple temperature profiles at different duration as follows: (1) Curing at 100° C. for a duration of 18 hours (2) Curing at 130° C. for a duration of 2 hours (3) Curing at 170° C. for a duration of 2 hours (4) Curing at 250° C. for a duration of 3 hours

### Example 7

Trans-Resveratrol tris (epoxide) (10 μm) was mixed with diethyltoluenediamine (DETDA) (10 μm)] and allowed to be cured open to the air at multiple temperature profiles at different duration as follows: (1) Curing at 80° C. for a duration of 2 hours (2) Curing at 100° C. for a duration of 1 hour (3) Curing at 120° C. for a duration of 1 hour (4) Curing at 160° C. for a duration of 1 hour (5) Curing at 200° C. for a duration of 4 hour

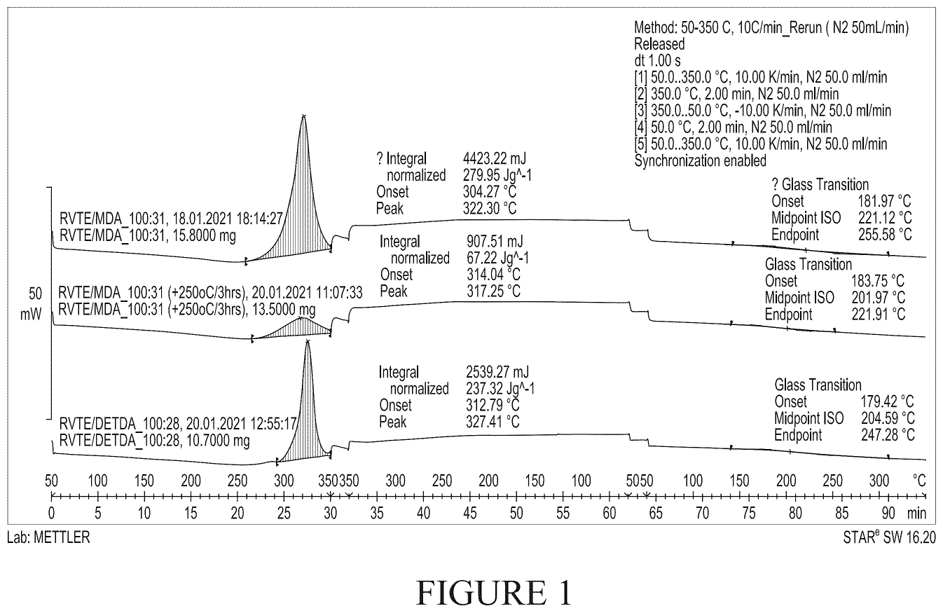

The results of Examples 5, 6 and 7 are summarized in Table 1. Profiles of glass transition temperature of RVTE systems in Examples 5, 6 and 7 are provided in FIG. 1.

TABLE 1

| | | | | Tg, |
|---|---|---|---|---|
| | Resin | Mixing Ratio | | midpoint |
| Example | System | (by weight) | Curing condition | (° C.) |
| 5 | RVTE/MDA | 100:31 | 100° C./18 hrs. + | 221.12^{(b)} |
| | | | 130° C./2 hrs. + | |
| | | | 170° C./2 hrs. + | |
| | | | 200° C./24 hrs. | |
| 6 | RVTE/MDA | 100:31 | 100° C./18 hrs. + | 201.97^{(b)} |
| | | | 130° C./2 hrs + | |
| | | | 170° C./2 hrs + | |
| | | | 200° C./24 hrs. + | |
| | | | 250° C./3 hrs. | |
| 7 | RVTE/ | 100:28 | 80° C./2 hrs. + | 204.59^{(b)} |
| | DETDA | | 100° C./1 hrs. + | |
| | | | 120° C./1 hrs. + | |
| | | | 160° C./1 hrs. + | |
| | | | 200° C./4 hrs. | |
| 8 | RVTE/ | 100:28 | 100° C./2 hrs. + | 257.13 (c) |
| | DETDA | | 160° C./2 hrs. + | |
| | | | 200° C./4 hrs. (a) | |
| 11 | RVTE/ | 100:28:0.5 | 100° C./2 hrs. + | 245.23 (c) |
| | DETDA/ | | 160° C./2 hrs. + | |
| | KINOX10 | | 200° C./4 hrs. (a) | |
| 12 | RVTE/ | 100:28:0.5:0.5 | 100° C./2 hrs. + | 257.80 (c) |
| | DETDA/ | | 160° C./2 hrs. + | |
| | KINOX10/ | | 200° C./4 hrs. (a) | |
| | KINOX68 | | | |

(a) *Specimens of Examples 5, 6 and 7 were cured in the glass bottle, under N2 and closed bottle with glass stopper.
^{(b)}DSC Program: 50-350° C., Rate 10K/min, N2 50 ml/min
(c) Tg by DSC (° C.) 50-300° C., Rate 1K/min, (TOPEM software) (midpoint)

The Examples 5, 6 and 7 exhibit Tg in the range of 200-221° C., whereas the examples 8, 11, 12 have higher Tg>245° C., showing fully optimized Tg when using antioxidants and excluding air (under nitrogen).

### Example 8

Trans-Resveratrol tris (epoxide) (2.8 μm) was mixed with diethyltoluenediamine (DETDA) (10 μm) in an oven at a temperature of 120° C. The mixture was allowed to be cured at multiple temperature profiles at different duration as follows:
[1] 40-250° C., Rate 25K/min, N2 50 ml/min [2] 250° C., 25 min, N2 50 ml/min
[3] 250-50° C., Rate −20K/min, N2 50 ml/min [4] 20° C., 5 min, N2 50 ml/min
[5] 20-280° C., Rate 10K/min, N2 50 ml/min

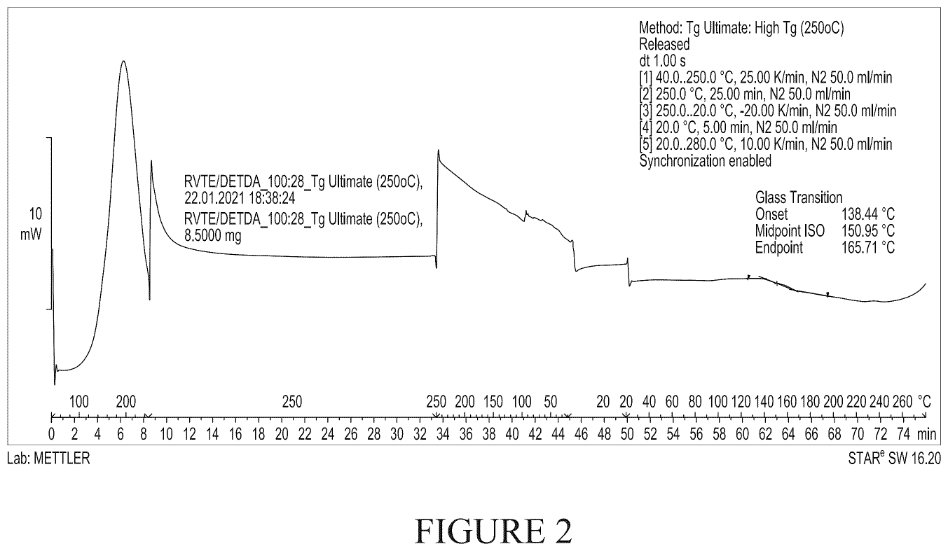

Profile of ultimate Tg of RVTE/DETDA systems of Example 5 is shown in FIG. 2.

### Example 9

Trans-Resveratrol tris (epoxide) (2.8 μm) was mixed with diethyltoluenediamine (DETDA) (10 μm) in an oven at a temperature of 120° C. The mixture was allowed to be cured at multiple temperature profiles at different duration as follows:
[1] 40-200° C., Rate 25K/min, N2 50 ml/min [2] 200° C., 25 min, N2 50 ml/min
[3] 200-50° C., Rate −20K/min, N2 50 ml/min [4] 20° C., 5 min, N2 50 ml/min
[5] 20-250° C., Rate 10K/min, N2 50 ml/min

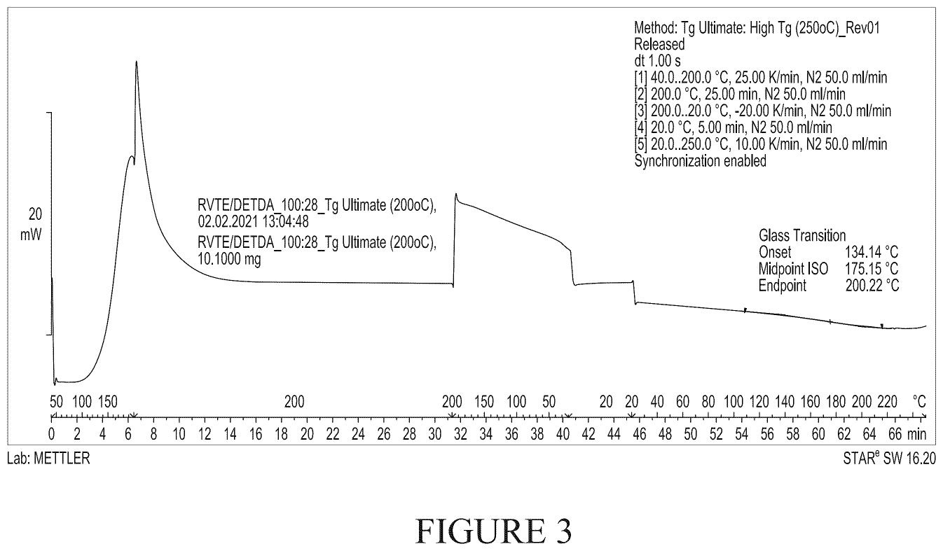

Profile of ultimate Tg of RVTE/DETDA systems of Example 7 is shown in FIG. 3.

### Example 10

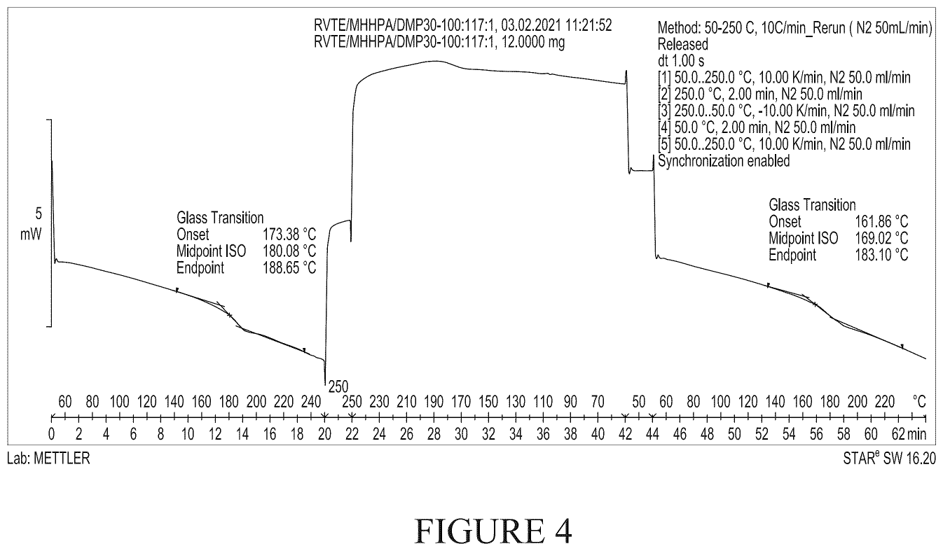

Trans-Resveratrol tris (epoxide) (10 μm) was mixed with methylhexahydrophthalic anhydride (MHHPA) (11.7 μm) and DMP-30 (1 μm) in an oven at a temperature of 120° C. The mixture was allowed to be cured at multiple temperature profiles at different duration as follows: (1) Curing at 100° C. for a duration of 2 hours (2) Curing at 160° C. for a duration of 1 hour (3) Curing at 200° C. for a duration of 24 hours. Glass transition temperature profile of thermoset systems comprising RVTE/MHHPA/DMP30 is shown in FIG. 4.

### Example 11

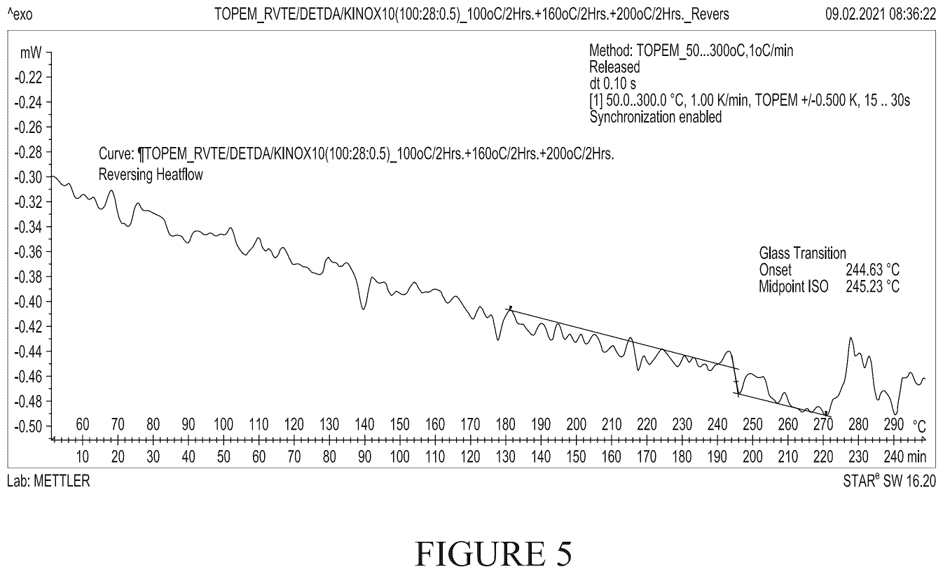

Trans-Resveratrol tris (epoxide) (10 μm) was mixed with DETDA (2.8 μm) and KINOX10 (0.5 μm) in an oven at a temperature of 120° C. The mixture was allowed to be cured at multiple temperature profiles at different duration as follows: (1) Curing at 100° C. for a duration of 2 hours (2) Curing at 160° C. for a duration of 2 hours (3) Curing at 200° C. for a duration of 4 hours. Glass transition temperature profile of thermoset systems comprising RVTE/DETDA/KINOX10 is shown in FIG. 5.

### Example 12

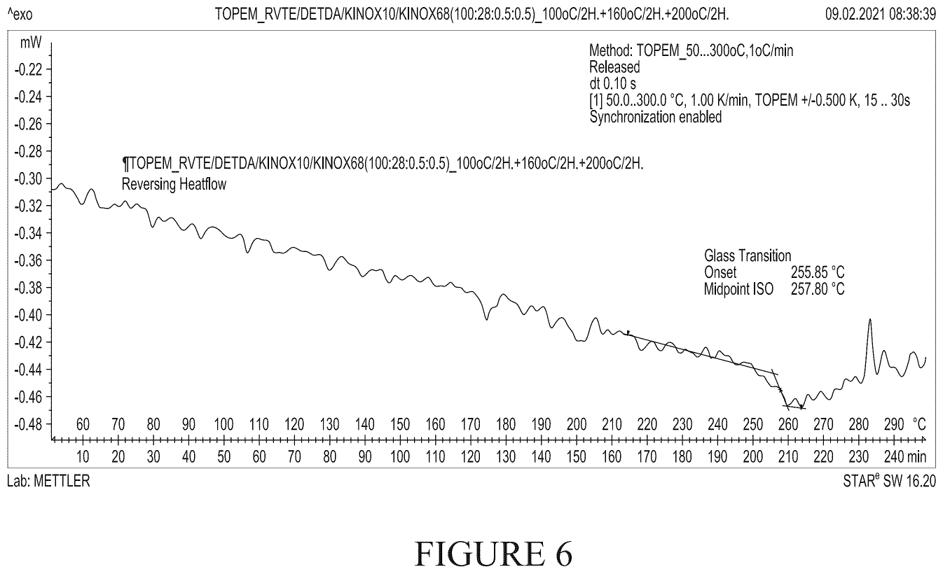

Trans-Resveratrol tris (epoxide) (10 μm) was mixed with DETDA (2.8 μm), KINOX10 (0.5 μm) and KINOX68 (0.5 μm) in an oven at a temperature of 120° C. The mixture was allowed to be cured at multiple temperature profiles at different duration as follows: (1) Curing at 100° C. for a duration of 2 hours (2) Curing at 160° C. for a duration of 2 hours (3) Curing at 200° C. for a duration of 4 hours. Glass transition temperature profile of thermoset systems comprising RVTE/DETDA/KINOX10/KINOX68 is shown in FIG. 6.

### Example 13

Trans-Resveratrol tris (epoxide) (10 μm) was mixed with DETDA (2.8 μm), KINOX10 (0.5 μm) and KINOX68 (0.5 μm) in an oven at 120° C. The mixture was allowed to be cured under nitrogen atmosphere in closed mold at multiple temperature profiles at different duration as follows: (1) Curing at 100° C. for a duration of 2 hours (2) Curing at 160° C. for a duration of 2 hours (3) Curing at 200° C. for a duration of 4 hours

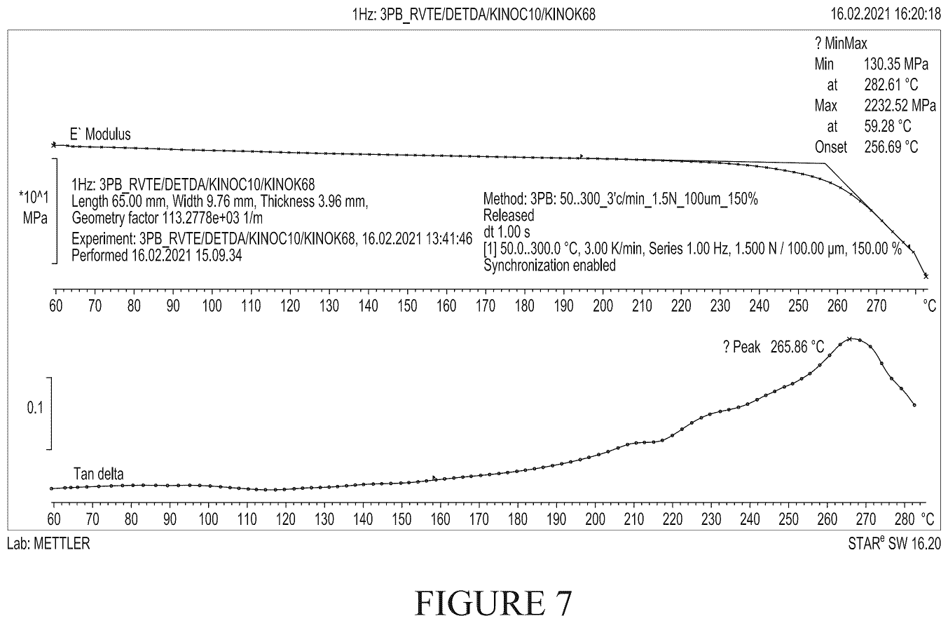

DMA profile of thermoset systems comprising RVTE/DETDA/KINOX10/KINOX68 is shown in FIG. 7.

### Example 14

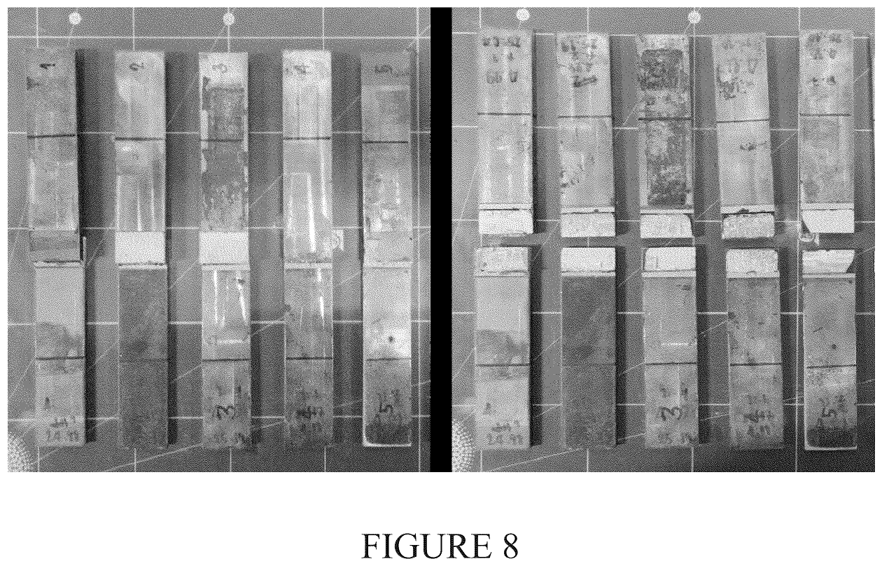

Trans-Resveratrol tris (epoxide) (10 μm) was mixed with DETDA (2.8 μm) in an oven at 120° C. As shown in FIG. 8, the mixture was applied on to the edge of two grit blasted steel substrates and a layer of 0.5 mm adhesive was formed at the edge of substrate. The substrate applied with the adhesive was allowed to be cured at multiple temperature profiles at different duration as follows: (1) Curing at 100° C. for a duration of 2 hours (2) Curing at 160° C. for a duration of 2 hours (3) Curing at 200° C. for a duration of 4 hours

Tensile lap shear strength of the substrates is measured by universal testing machine and shown in Table 2. The high value of tensile lap shear strength is indicative of its high bonding or adhesive strength.

TABLE 2

| | | | Tensile lap shear | |
|---|---|---|---|---|
| | Mixing Ratio | | strength (MPa) | |
| Materials | (by weight) | Curing condition | Mean | SD |
| RVTE/ | 100:28 | 100° C./2 hrs. + | 12.18 | 0.395 |
| DETDA | | 160° C./2 hrs. + | | |
| | | 200° C./4 hrs. | | |

### Example 15

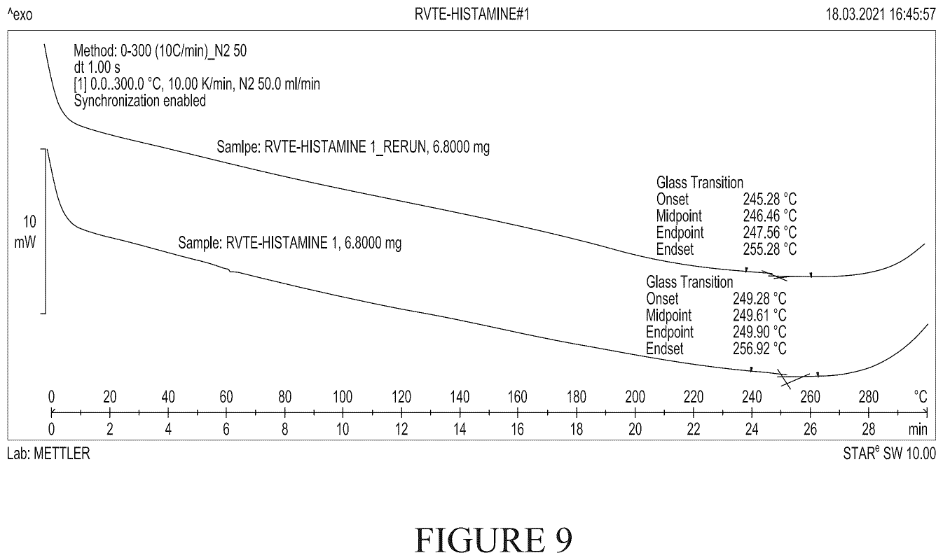

Trans-Resveratrol tris (epoxide) (10 μm) was mixed with histamine (2.3 μm) preheated in an oven at a temperature of 120° C. The mixture was allowed to be cured at multiple temperature profiles at different duration as follows: (1) Curing at 100° C. for a duration of 1 hour (2) Curing at 200° C. for a duration of 1 hour (3) Curing at 250° C. for a duration of 1 hour. Glass transition temperature profile of thermoset systems comprising RVTE and histamine is show in FIG. 9.

The examples above illustrate the Tg values of RVTE epoxy resin with variety of curing agents; aromatic amines, anhydride and naturally occurring aliphatic polyamine (histamine). In all examples the cured epoxy system exhibits high Tg with highest Tg realized in examples that used antioxidants. Dynamic mechanical analysis (DMA) of example with antioxdiants indicated loss in storage modulus (E′) beyond 250° C. Results of Tg measurements from all examples indicate suitability of cured epoxy thermoset matrix for high temperature resistant applications.

The above examples are non-limiting. The invention is defined by the claims that follow:

We claim:

1. A method of curing an epoxide prepared from phenolic compounds such that the cured epoxy resin has a glass transition temperature (Tg) of at least 245° C., the method comprising:
(a) mixing the epoxide at a temperature of 25 to 100° C. with
at least one hardener, a naturally occurring aliphatic polyamine or at least one analogue thereof or combination thereof, and at least one antioxidant
(b) heating the mixture of step (a) at 100 to 130° C. for 1 to 3 hrs;
(c) heating the partially cured mixture of step (b) at 130 to 160° C. for 1 to 3 hrs; and
(d) heating the substantially cured mixture of step (c) at 160 to 200° C. for 3 to 5 hrs;
wherein steps (b) to (d) were performed in an atmosphere of nitrogen; and
wherein the epoxide is trans-resveratrol trisepoxide of Formula I, a tetraepoxide of Formula II or a diepoxide of Formula III,

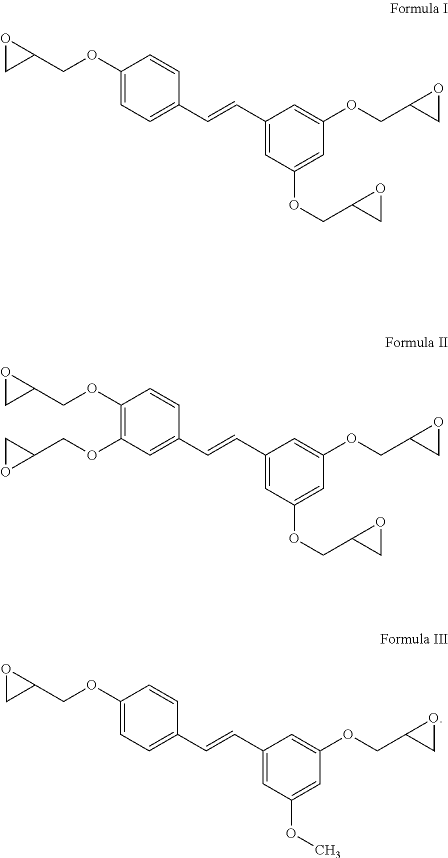 [SMILES: C(=C\c1cc(OCC2CO2)cc(OCC2CO2)c1)/c1ccc(OCC2CO2)cc1 ; C(=C\c1ccc(OCC2CO2)c(OCC2CO2)c1)/c1cc(OCC2CO2)cc(OCC2CO2)c1 ; COc1cc(/C=C/c2ccc(OCC3CO3)cc2)cc(OCC2CO2)c1]

2. The method as claimed in claim 1, wherein the phenolic compound is trans-resveratrol.

3. The method as claimed in claim 1, wherein the hardener is diethyltoluenediamine (DETDA), 4,4′-methylenedianiline (MDA), or combinations thereof.

4. The method as claimed in claim 1, wherein the antioxidant is a primary phenolic antioxidant, a secondary phosphite anti-oxidant or a combination thereof.

5. The method as claimed in claim 1, wherein the naturally occurring aliphatic polyamine is histamine.

6. The method as claimed in claim 1, wherein the weight ratio of epoxide:hardener:antioxidant is in the range of 100:25:0.2 to 100:35:1.

7. Use of the cured epoxide prepared by the method of claim 1 for preparing high Tg epoxy-based adhesives, electronic moulding compounds, composites and powder coatings.
